(19) United States
(12) Patent Application Publication
(10) Pub. No.: US 2023/0243747 A1
(43) Pub. Date: Aug. 3, 2023

(54) SUBSTRATE FOR FLUORESCENCE ENHANCEMENT AND FLUORESCENCE DETECTION DEVICE HAVING THE SAME

(71) Applicant: NATIONAL SUN YAT-SEN UNIVERSITY, Kaohsiung City (TW)

(72) Inventors: Yu-Ju Hung, Kaohsiung City (TW); Yeo-Wan Chiang, Kaohsiung City (TW); Chung-Ting Chang, Kaohsiung City (TW); Xiang-Fa Wu, Kaohsiung City (TW); Ci-Ren Chen, Kaohsiung City (TW)

(21) Appl. No.: 17/742,475

(22) Filed: May 12, 2022

(30) Foreign Application Priority Data
Jan. 28, 2022 (TW) 111104032

(51) Int. Cl. G01N 21/64

(52) U.S. Cl. CPC G01N 21/6428; G01N 21/645; G01N 2021/6439; G01N 2021/6463

(57) ABSTRACT

A fluorescence detection device of the present invention includes a substrate and a light source. A fluorescence enhancement layer of the substrate includes a photonic crystal which is formed from a block copolymer thus in the combination with metal particles or a metal film. An excitation light generated from the light source can illuminate a fluorescent material placed on the fluorescence enhancement layer to induce emission of a fluorescence from the fluorescent material. The fluorescence enhancement layer is provided to enhance luminous efficiency of the fluorescence, thus improving fluorescence detection sensitivity.

### FIELD OF THE INVENTION

This invention relates to a substrate for fluorescence enhancement, and more particularly to a substrate capable of increasing fluorescence emission through photonic crystal.

### BACKGROUND OF THE INVENTION

Fluorescence detection technique can be employed in biomedical, food safety and environmental safety detections. A specimen is labeled with fluorescent molecules and illuminated with light of specific wavelength to excite electrons across band gap. As the excited electrons return to ground state, the energy is released in the form of fluorescence, and fluorescence intensity is measured by an optical instrument so as to indirectly identify the quantity of the specimen. However, a false detection may occur caused by environmental noise while the intensity of fluorescence is too low.

### SUMMARY

One object of the present invention is to provide a substrate for fluorescence enhancement which includes a photonic crystal used to improve fluorescence emission, thus enhancing fluorescence detection sensitivity.

A substrate for fluorescence enhancement of the present invention includes a carrier and a fluorescence enhancement layer located on a surface of the carrier. The fluorescence enhancement layer includes a photonic crystal formed from a block copolymer, and there are a plurality of pores in the photonic crystal.

A fluorescence detection device includes a substrate for fluorescence enhancement and a light source. The substrate includes a carrier and a fluorescence enhancement layer located on a surface of the carrier. The fluorescence enhancement layer includes a photonic crystal formed from a block copolymer, and there are a plurality of pores in the photonic crystal. The light source is provided to generate an excitation light used to illuminate a fluorescent material placed on the fluorescence enhancement layer to cause the emission of a fluorescence from the fluorescent material. The fluorescence enhancement layer is provided for enhancing luminous efficiency of the fluorescence.

### DESCRIPTION OF THE DRAWINGS

FIG. 1 is a cross-section view diagram illustrating a fluorescence detection device in accordance with a first embodiment of the present invention.

FIG. 2 is a cross-section view diagram illustrating a fluorescence detection device in accordance with a second embodiment of the present invention.

FIG. 3 is a cross-section view diagram illustrating a fluorescence detection device in accordance with a third embodiment of the present invention.

FIG. 4 shows the results of fluorescence detection.

FIG. 5 shows the results of fluorescence detection.

### DETAILED DESCRIPTION OF THE INVENTION

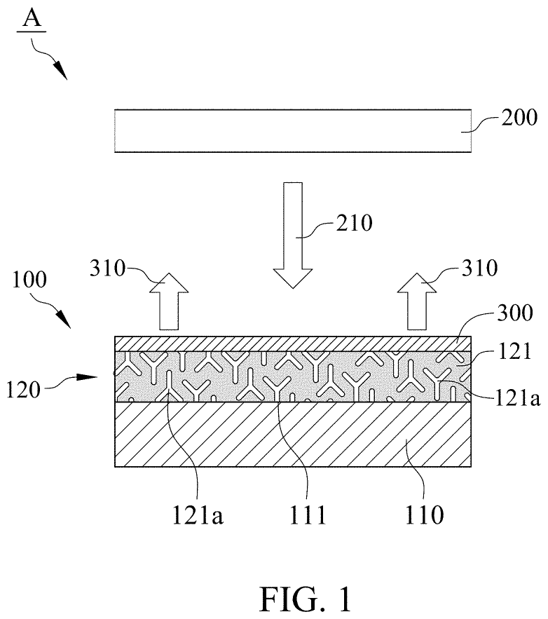

With reference to FIG. 1, a fluorescence detection device A of a first embodiment of the present invention includes a substrate 100 for fluorescence enhancement and a light source 200. The substrate 100 includes a carrier 110 and a fluorescence enhancement layer 120 which is located on a surface 111 of the carrier 110. The carrier 110 can be made of any material, preferably, it may be made of glass, plastic, silicon or paper. The light source 200 is provided to generate an excitation light 210, preferably, the light source 200 is installed in a fluorescence microscope. As user places a fluorescent material 300 on the substrate 100, the excitation light 210 illuminates the fluorescent material 300, causing emission of a fluorescence 310 from the fluorescent material 300. The fluorescence enhancement layer 120 is provided to enhance luminous efficiency of the fluorescence 310 so as to increase fluorescence emission and fluorescence detection sensitivity for low concentration analyte. The fluorescent material 300 may be fluorescent dye, fluorescent protein, antibody or antigen labeled with fluorescent molecules.

With reference to FIG. 1, the fluorescence enhancement layer 120 includes a photonic crystal 121 which is formed from a block copolymer and is porous. The block copolymer may be an amphiphilic block copolymer able to self-assemble into a photonic crystal having three-dimensional(3D) periodic network structures, thus there are a plurality of pores 121a in the photonic crystal 121. Preferably, the amphiphilic block copolymer is polystyrene-block-poly(vinylpyridine) (PS-PVP), and more preferably, the amphiphilic block copolymer is polystyrene-block-poly(2-vinylpyridine) (PS-P2VP) or polystyrene-block-poly(4-vinylpyridine) (PS-P4VP).

In the first embodiment of the present invention, a PS-P2VP copolymer solution is coated onto a substrate to form an initial film. During the coating process, PS-P2VP copolymer self-assembles into 3D periodic network structures which may be gyroid microstructures, interconnected network microstructures or other 3D ordered network microstructures. Next, the initial PS-P2VP film is soaked in a polar solvent, such as ethanol, and the P2VP chains in the PS-P2VP copolymer is swollen in the polar solvent to increase the periodicity of the 3D network structures, as a result, the periodicity of the 3D network structures in the solvated PS-P2VP film is greater than that in the PS-P2VP initial film. Then, the solvated PS-P2VP film is taken out from the polar solvent to be dried. During evaporation of the polar solvent, the swollen P2VP chains become glassy and generate a thin glassy layer covering onto the film surface. After complete evaporation of the polar solvent, owing to the thin glassy layer on the film surface can trap the periodicity of the 3D network structures, the periodicity of the 3D network structures in the solid PS-P2VP film is not reverted, it is preserved between that in the initial PS-P2VP film and the solvated PS-P2VP film, and the solid PS-P2VP film is a solid photonic crystal. The solid photonic crystal is transferred onto the surface 111 of the carrier 110 and used as the photonic crystal 121. In other embodiments, the photonic crystal 121 can be formed on the surface 111 of the carrier 110 directly.

The 3D network structures in the photonic crystal 121 can help to grab more fluorescent material 300 and provide phase-matching conditions for Bloch surface wave (BSW) excitation, thus BSW resonance can enhance the luminous efficiency of the fluorescence 310. Furthermore, the thicker the photonic crystal 121, the greater BSW resonance effect, that is to say the thicker photonic crystal 121 having more layers of periodic network structures is better to improve BSW resonance.

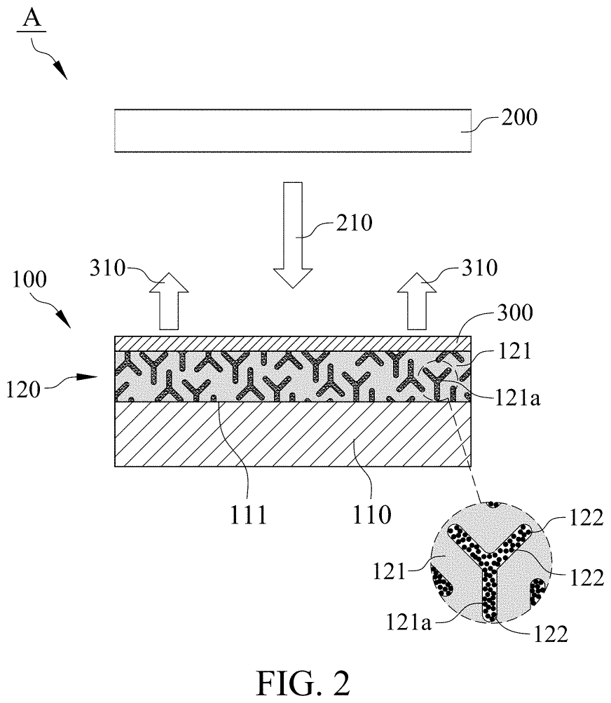

FIG. 2 shows a fluorescence detection device A of a second embodiment of the present invention. In the second embodiment, the fluorescence enhancement layer 120 further includes a plurality of metal particles 122. Preferably, a solution having the metal particles 122 is applied to the surface of the photonic crystal 121 to allow the metal particles 122 to be distributed in the pores 121a of the photonic crystal 121. The metal particles 122 may be made of gold, silver, copper, aluminum, or other metals.

The periodic porous structures in the photonic crystal 121 and the metal particles 122 act as a coupling source so that localized surface plasmons and Bloch surface wave can be excited by the metal particles 122 and the photonic crystal 121 to enhance electromagnetic field as the excitation light 210 illuminates the substrate 100. The enhanced electromagnetic field can act on the fluorescent material 300, more electrons may absorb energy to jump from ground state to excited state, and more excited electrons may return to ground state to release energy in the form of fluorescence. Consequently, the fluorescence enhancement layer 120 can increase the emission of the fluorescence 310.

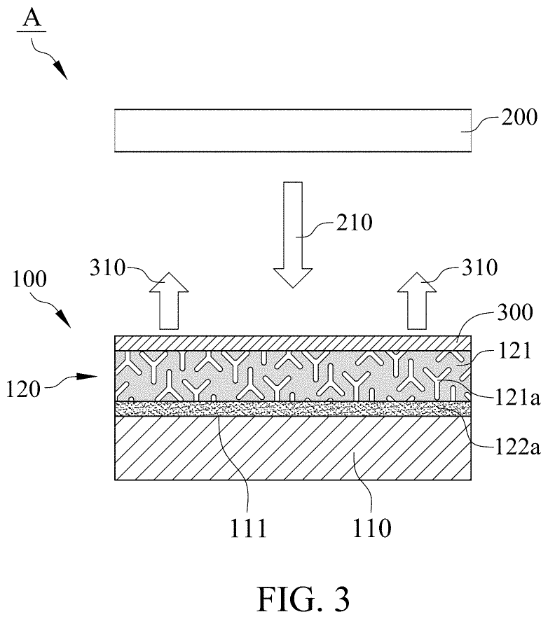

With reference to FIG. 3, it presents a third embodiment of the present invention. Different to the second embodiment, the metal particles 122 of the third embodiment are deposited on the surface 111 of the carrier 110 to form a metal film 122a before transferring the photonic crystal 121 onto the carrier 110 such that the metal film 122a is located between the carrier 110 and the photonic crystal 121. Preferably, the metal film 122a is a smooth metal film with a thickness of between 40 nm and 50 nm. There are many generations of surface plasmons between the metal film 122a and the photonic crystal 121 owing to the porous structures in the photonic crystal 121. In the third embodiment, the metal film 122a could be gold, silver, copper or aluminum film located on the surface 111 of the carrier 110. And based on different requirements, the metal film 122a may cover the surface 111 of the carrier 110 completely or partially.

If the fluorescent material 300 is too close to the metal film 122a, a phenomenon called “energy transfer quenching” may occur, energy of the excited electrons which are too close to metal may be absorbed by metal while the excited electrons return to ground state, and the energy cannot be released in the form of photons. On the other hand, if the fluorescent material 300 is too far away from the metal film 122a, surface plasmons on metal surface cannot interact with the fluorescent material 300 to excite electrons and emit fluorescence. Accordingly, the distance between the fluorescent material 300 and the metal film 122a is closely related to fluorescence emission.

The photonic crystal 121 in the third embodiment is located between the fluorescent material 300 and the metal film 122a, as a result, it is available to adjust the distance from the fluorescent material 300 to the metal film 122a by varying the thickness of the photonic crystal 121. The thickness of the photonic crystal 121 is preferably not greater than 3 μm, and more preferably between 0.5 μm and 3 μm. The photonic crystal 121 can maintain the proper distancing between the fluorescent material 300 and the metal film 122a to allow surface plasmons to increase luminous efficiency of the fluorescence 310 effectively.

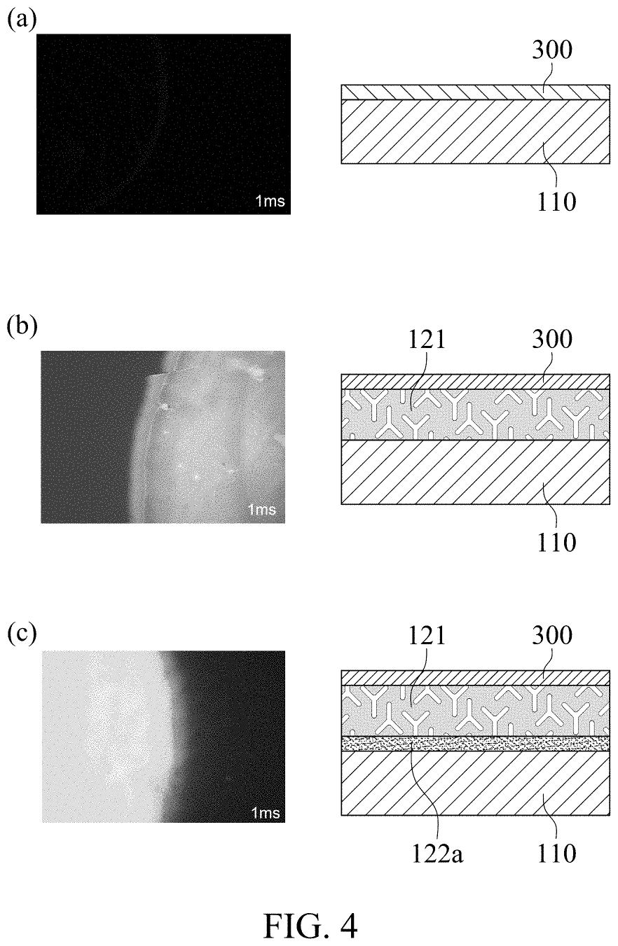

FIG. 4 shows the results of fluorescence detection. The carrier 110 is made of glass, the photonic crystal 121 is formed by self-assembly of PS-P2VP, the metal film 122a is a silver film, the light source 200 is a mercury-vapor lamp in fluorescence microscope. The mercury-vapor lamp emits white light, the white light is filtered into green light after passing through a filter, the green light illuminates the fluorescent material 300 which is 126.3 ppm rhodamine 6G (R6G), fluorescence emitted by the fluorescent material 300 is reflected to the fluorescence microscope and then passed through another filter to be filtered to red light, exposure time is 1 ms.

FIG. 4a is the result of control group using a control device, R6G is dropped on a glass carrier directly, FIG. 4b is the result of experiment group using a substrate of the first embodiment of the present invention, a PS-P2VP photonic crystal is transferred to the surface of a glass carrier and R6G is dropped on the PS-P2VP photonic crystal, and FIG. 4c is the result of another experiment group using a substrate of the third embodiment of the present invention, a silver film is formed on a glass carrier, a PS-P2VP photonic crystal is transferred to the surface of the glass carrier and R6G is dropped on the PS-P2VP photonic crystal. The results demonstrate that Bloch surface waves induced by periodic network structures in the photonic crystal 121 actually can enhance luminous efficiency of the fluorescence 310, and also demonstrate that surface plasmons excited by periodic network structures in the photonic crystal 121 and the metal film 122a can further enhance luminous efficiency of the fluorescence 310.

The periodicity of the 3D network structures in the photonic crystal 121 is tunable by changing the time required for complete evaporation of the polar solvent, thus the periodicity of the 3D network structures in the photonic crystal 121 in combination with the metal film 122a can be modified between 150 nm and 300 nm for enhancing luminous efficiency of different fluorescent materials.

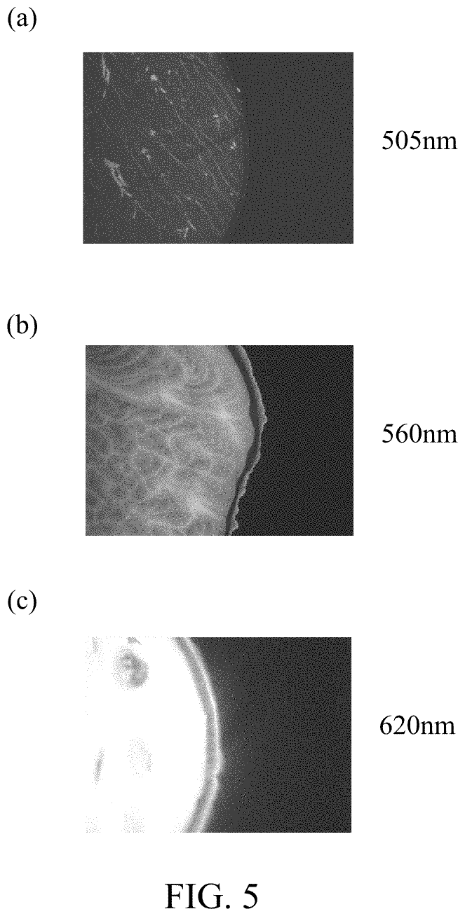

Photonic crystals having different reflectance wavelengths can cause different luminous efficiency of the same fluorescent material 300. As the reflectance wavelength of the photonic crystal 121 is more similar to the wavelength of the fluorescence 310, the luminous efficiency of the fluorescent material 300 is better. FIG. 5 shows the results of fluorescence detection using the photonic crystals 121 having different reflectance wavelengths and located on the metal film 122a, the fluorescent material 300 is 126.3 ppm R6G, exposure time is 1 ms, the reflectance wavelengths of the photonic crystals as shown in FIGS. 5a, 5b and 5c are 505 nm, 560 nm and 620 nm respectively. 620 nm is closer to the fluorescence wavelength of R6G than 505 nm and 560 nm, consequently, the photonic crystal 121 having a reflectance wavelength of 620 nm can achieve the best luminous efficiency.

Because of Bloch surface waves supported by the photonic crystal 121 and surface plasmon wave generated between the photonic crystal 121 and the metal film 122a, the substrate 100 of the present invention is capable of being applied to a fluorescence detection device to enhance luminous efficiency of the fluorescence 310 and fluorescence detection sensitivity significantly. The fluorescence detection device A having the substrate 100 for fluorescence enhancement can sense fluorescence signal even when the concentration of fluorescent molecules is lower than 10⁻⁷ ppm. Moreover, the photonic crystal 121 is extendable, flexible and prepared simply so a fluorescence detection device with low cost and high sensitivity is available.

While this invention has been particularly illustrated and described in detail with respect to the preferred embodiments thereof, it will be clearly understood by those skilled in the art that is not limited to the specific features shown and described and various modified and changed in form and details may be made without departing from the scope of the claims.

What is claimed is:

1. A substrate for fluorescence enhancement comprising:
a carrier; and
a fluorescence enhancement layer located on a surface of the carrier and including a photonic crystal, the photonic crystal is formed from a block copolymer and there are a plurality of pores in the photonic crystal.

2. The substrate in accordance with claim 1, wherein the photonic crystal includes a three-dimensional network structure of the block copolymer.

3. The substrate in accordance with claim 2, wherein a periodicity of the three-dimensional network structure is between 150 nm and 300 nm.

4. The substrate in accordance with claim 1, wherein the block copolymer is an amphiphilic block copolymer.

5. The substrate in accordance with claim 4, wherein the amphiphilic block copolymer is polystyrene-block-poly(vinylpyridine).

6. The substrate in accordance with claim 4, wherein the amphiphilic block copolymer is polystyrene-block-poly(2-vinylpyridine) or polystyrene-block-poly(4-vinylpyridine).

7. The substrate in accordance with claim 1, wherein the fluorescence enhancement layer further includes a plurality of metal particles which are distributed in the plurality of pores of the photonic crystal.

8. The substrate in accordance with claim 7, wherein materials of the plurality of metal particles are selected from the group consisting of gold, silver, copper and aluminum.

9. The substrate in accordance with claim 1, wherein the fluorescence enhancement layer further includes a metal film which is located between the carrier and the photonic crystal.

10. The substrate in accordance with claim 9, wherein material of the metal film is selected from the group consisting of gold, silver, copper and aluminum.

11. The substrate in accordance with claim 9, wherein the metal film has a thickness between 40 nm and 50 nm.

12. The substrate in accordance with claim 1, wherein the photonic crystal has a thickness less than or equal to 3 μm.

13. A fluorescence detection device comprising:
a substrate for fluorescence enhancement including a carrier and a fluorescence enhancement layer, the fluorescence enhancement layer is located on a surface of the carrier and includes a photonic crystal, the photonic crystal is formed from a block copolymer and there are a plurality of pores in the photonic crystal; and
a light source configured to generate an excitation light, the excitation light is configured to illuminate a fluorescent material placed on the fluorescence enhancement layer to cause emission of a fluorescence from the fluorescent material, the fluorescence enhancement layer is configured to enhance luminous efficiency of the fluorescence.
